(19) United States
(12) Patent Application Publication
(10) Pub. No.: US 2008/0180256 A1
(43) Pub. Date: Jul. 31, 2008

(54) Method and remote motion-activated training apparatus to stop dogs from digging

(76) Inventor: Richard Christian Caldwell, Meridian, ID (US)

Correspondence Address: Richard Christian Caldwell, 1461 Calistoga Ave., Meridian, ID, 83642, US

(21) Appl. No.: 12/009,348

(22) Filed: Jan. 19, 2008

Related U.S. Application Data
(60) Provisional application No. 60/897,037, filed on Jan. 24, 2007.

(51) Int. Cl. G08B 23/00

(52) U.S. Cl. 340/573.3

(57) ABSTRACT

A remote motion-activated transmitter unit for use in a animal behavior modification system which transmits a signal to activate a shock collar. The remote motion-activated transmitter is to be buried in the existing filled dog-hole. It is activated by the motion created by a digging animal when it returns to the filled hole to repeat it's digging activity. The motion sensing feature of the remote motion-activated transmitter is innovative in that it automatically sends the correction signal to shock collar at the exact time the misbehavior occurs. The transmitter circuit is designed to activate the shocking device when it senses motion.

### BACKGROUND

Effective dog training to prevent and correct the hole-digging behavior of dogs does not exist. Prior technology exists in the form of a shock collar and hand-held transmitter. The problem is that it relies on the human intervention to apply the shock stimulus to animal. In most cases, the dog owner discovers the evidence of the misbehavior—a hole in the ground—after the misbehavior has occurred. Any shock stimulus given to dog after the misbehavior has occurred is not interpreted by the dog as a correction for past activities and rarely cures the animal of digging holes.

Another technology or method exists of a “barrier” type of determent. With this technology, a underground wire or radio transmission system is installed in a zone which the pet owner wants off-limits to the pet. When the shock collar that is worn around the pet's neck reaches a location or proximity to the signal, the receiver/shock collar provides a electrical stimulus to pet. This teaches the animal to avoid certain area, and not the desired training to correct the dog digging behavior.

Other incorrect inhumane methods of training digging dog is to fill the hole with water and dunking the dogs head, spraying the dog with pepper spray, beating or kicking. These methods do not work and are inhumane.

### BRIEF SUMMARY

The general idea is to correct the animal at the exact time it digs and to provide the animal with a reactive mechanism or correction to only the unwanted activity. This remote-activated transmitter does this. The advantage is that the animal will be trained to learn that if the specific activity occurs again at that hole, it will get the reaction necessary—activated shock collar stimulus—to deter that behavior. The animal is not smart enough to know that the rest of the yard, or holes, may not have the in-ground remote sensor. The animal only knows that it received a shock in response to the activity of digging.

### BRIEF DESCRIPTION OF DRAWINGS

FIG. 1 shows the animal behavior modification system which comprises a remote motion-activated transmitter 10, the transmitted signal 24 to receiver unit 20, the dog collar 12 of which is attached the receiving unit 20. The electrodes 16 18 are shown.

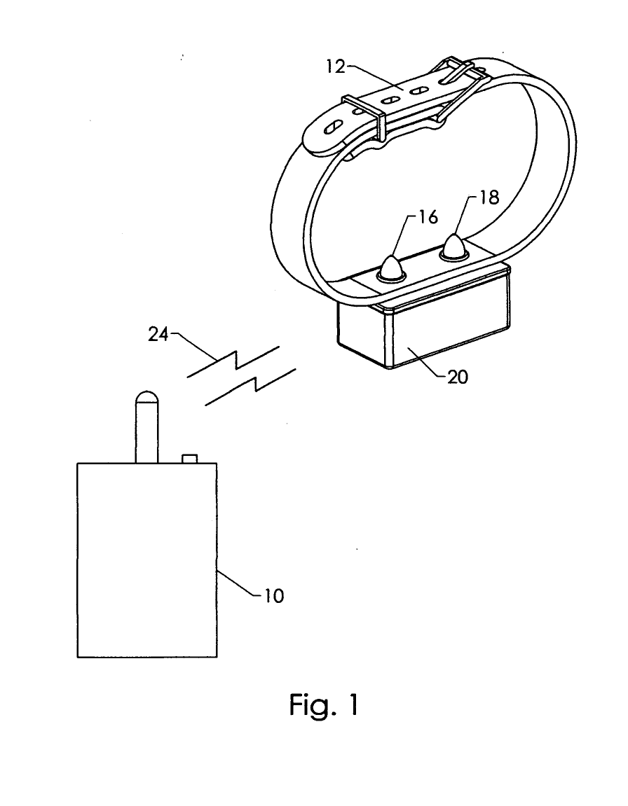

FIG. 2 shows the remote motion-activated transmitter electrical block diagram which comprises a transmitter 31, antenna 34, transmitter switch lines 32 33, transmitter on/off relay 30, multivibrator debouncer circuit 22, RC delay network resistor 26 and capacitor 25, motion switch 23, pull-down resistor 21, ground 36, multivibrator input 35, multivibrator output 28.

### DETAILED DESCRIPTION OF INVENTION

Transmitter 31 comprises a internal stimulation adjust control for setting a stimulation level parameter in a transmitted radio signal and internal, a power switch or activation switch for controlling transmission of radio signal, and an antenna 34 through which radio signal is transmitted by transmitter. Transmitter 31 may employ any of a number of modulation formats for encoding control information in radio signal for communication to receiver unit 20. In the disclosed embodiment of the invention, the control information is digitally encoded, although analog signals may be used as well, provided appropriate analog to digital conversion circuitry is included in receiver unit 20. In the preferred embodiment, control signals are FM signals transmitted at 27 MHz. Receiver unit 20 converts received control signals to an intermediate frequency (IF) of 455 KHz which is amplified and demodulated.

A security code transmitted to the receiver unit to which the control information is being sent, and a stimulation level code transmitted in second field identifies the strength of the electrical stimulation to be applied to collar electrodes 16 18. In the preferred embodiment, the stimulation level indicated by stimulation adjust controller is converted to digital format by transmitter 31 and stored in second field. A security code specific to transmitter 31 is stored in first data field to ensure that data packet is processed only by its intended receiver 20. It is noted that many other well-known modulation/demodulation schemes may be used for coding data. In the disclosed scheme, header of data packet is indicated by a 2 millisecond (ms) high state followed by a 2 ms low state. Thereafter, each bit of first and second data fields is represented by a 3 ms long data cell in which digital ones are represented by a 2 ms high state followed by a 1 ms low state, and digital zeroes are represented by a 1 ms high state followed by a 2 ms low state. In the disclosed embodiment, header is followed by a 9-bit identity code in first data field and a 4-bit stimulation code in second data field. The 4 bit code allows a trainer to select from among 16 different levels of electrical stimulation for conditioning an animal's response, and the number of different levels of electrical stimulation can be easily expanded by increasing the number of bits in data field.

Motion-controlled activation of the transmitter 31 comprises a motion sensing switch 23, a RC network, and a relay to open and close the switch control lines 32 33 of transmitter 31. It also comprises a current limiting resistor 21, and multivibrator integrated circuit 22. Twelve volts is supplied to resistor 21 and motion sensing switch 23. The high resistance of resistor 21, 3.3 mohm, will minimize the current draw to ground 36 but still allow enough voltage to the sensing input 35 of multivibrator 22. The motion sensing switch 23, upon activated by motion, will close and draw the voltage and current from resistor 21 to ground 36. The multivibrator 22 acts as a signal debouncer. The multivibrator input 35 will sense the drop in voltage and will send a positive signal from output 28 to activate and close relay 30 and activate internal transmitter switch via lines 32 33. The transmitter 31 will then send the IF coded signal to receiver 20. The receiver 20, upon receiving receiving the code signal, will generate electrical stimulus to the animal via two electrodes 16 18. Since some of the listed technology is not new 31 20, the full detail of embodiment 31 20 is not listed.

The RC network resistor and capacitor 25 26 determines the length of relay 30 closure and transmitter 31 transmission through antenna 34. Generally 2 seconds of stimulus to animal is enough to deter dog behavior. Time-delay resistor 26 is set to 75K ohm and time-delay capacitor 25 is set to 10 uF. With the new range limiting feature, the antenna 34 length is minimized or in some cases removed completely to reduce the transmitter 10 IF signal 24 amplitude to restrict range to approx. 6 ft radius to allow only the receiver(s) 20 that is in proximity to the motion-activated remote transmitter 10, to activate.

What distinguishes this invention from other inventions is the remote motion-activated feature which generates a automatic stimulus signal 24 to be transmitted from the remote motion-activated transmitter 10 to receiver 20 for a pre programmed length of time only when motion is sensed.

The new range-limiting feature allows the use of 2 or more motion-activated remote transmitters 10, to be positioned greater than 6 feet away from each other and to function independently with receiver unit 20 by not allowing signal 24 interference between multiple transmitters 10. This will allow the animal a quick getaway by the animal moving outside of the 6 ft radius of activating signal 24.

While this invention has been described as having a preferred design, the present invention can be further modified within the spirit and scope of this disclosure. This application is therefore intended to cover any variations, uses, or adaptations of the invention using its general principles.

Further, this application is intended to cover such departures from the present disclosure as come within known or customary practice in the art to which this invention pertains and which fall within the limits of the appended claims.

What is claimed is:

I. A remote motion-activated transmitter unit for use in animal behavior modification system that sends a stimulus signal to receiver unit which applies electrical shock to animal, said remote motion-controlled transmitter unit comprising motion activation which activates transmitter to send signal to receiver when motion is detected.

II. A method to train an animal from digging holes comprising: at least one remote motion-activated transmitter placed in hole for sensing the animals digging activity, wherein the at least one remote motion-activated transmitter includes a motion switch to detect motion caused by the animals digging and transmits a stimulus signal to receiving unit in response to digging motion.

III. A method to train an animal from digging holes comprising: at least one remote motion-activated transmitter placed in hole for sensing the animals digging activity, wherein at least one remote motion-activated sensor includes a motion switch to detect motion caused by the animals digging.

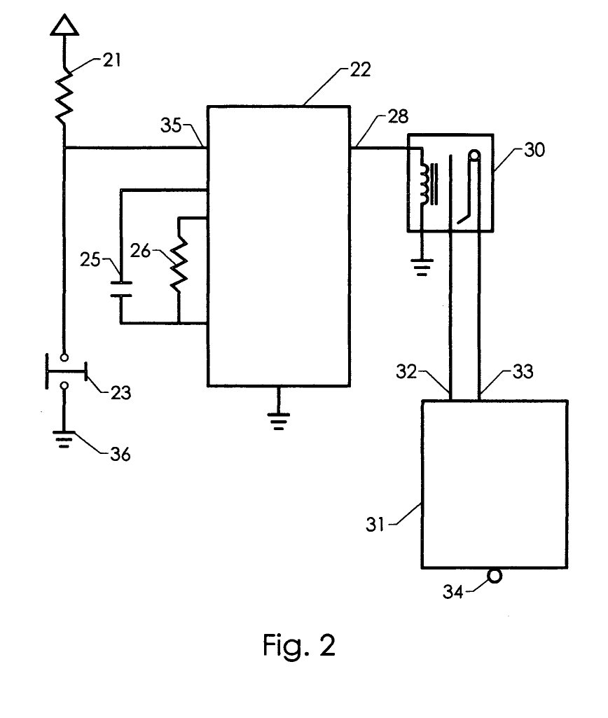

IV. A remote motion-activated transmitter unit for use in animal behavior modification system that sends a stimulus signal to receiver unit which applies electrical shock to animal, said remote motion-controlled transmitter unit comprising motion activation which activates transmitter to send signal to receiver when motion generated from dog digging activity occurs. The remote motion-activated transmitter unit of claim I, IV, VI, further comprising a hermetically sealed box containing said transmitter 31 and motion-control circuit of FIG. 2.

V. A remote motion-activated transmitter unit for use in animal behavior modification system that sends a stimulus signal to receiver unit in response to sensed motion, which said receiver unit applies electrical shock to animal, said remote motion-controlled transmitter unit comprising: motion-control circuit FIG. 2 and transmitter.
